(19) United States
(12) Patent Application Publication
(10) Pub. No.: US 2026/0238084 A1
(43) Pub. Date: Aug. 13, 2026

(54) POWERING AND CONTROLLING AN ELECTRIC BRUSHLESS MOTOR IN A POWER TOOL WITH A DUAL MODE MOTOR CONTROL

(71) Applicant: ROBBOX INC., Burnaby (CA)

(72) Inventor: Andrei Matei, Coquitlam (CA)

(73) Assignee: ROBBOX INC., Burnaby, BC (CA)

(21) Appl. No.: 19/534,166

(22) Filed: Feb. 9, 2026

Related U.S. Application Data
(60) Provisional application No. 63/755,648, filed on Feb. 7, 2025.

(51) Int. Cl. H02K 7/14; B23B 45/00; B23B 45/02; H02K 11/00; H02K 11/215; H02K 11/33; H02P 21/00; H02P 21/04; H02P 21/18; H02P 21/24; H02P 21/36; H02P 23/00; H02P 23/24

(52) U.S. Cl. CPC H02K 7/145; B23B 45/001; B23B 45/02; H02K 11/0094; H02K 11/215; H02K 11/33; H02P 21/0021; H02P 21/04; H02P 21/18; H02P 21/24; H02P 21/36; H02P 23/0027; H02P 23/24; B23B 2260/0482; B23B 2260/0487; B23B 2260/128; H02P 2207/05

(57) ABSTRACT

Powered hand tools with a dual mode motor control and, in particular, their combination with a laser measuring system and a touch interactive screen. The dual mode motor control comprises a first mode and a second mode, the first mode being sensored and the second mode being sensorless implementing a Field Oriented Control angle estimator. According to the disclosure, the laser measuring system is provided to operate functions of powered hand tools, and the touch interactive screen is provided to operate functions and control parameters of powered hand tools.

### CROSS-REFERENCE TO RELATED APPLICATIONS

The present application claims priority to U.S. Provisional Application No. 63/755,648, filed Feb. 7, 2025, the teaching of which is hereby incorporated by reference in its entirety.

### BACKGROUND

### Field of the Disclosure

The present disclosure relates to powered hand tools with a dual mode motor control and their combination with a laser measuring system and a touch interactive screen.

### Description of the Related Art

Traditionally, conventional power tools use a single mode motor control, such as a sensored Electronic Speed Control using a trapezoidal method with no accurate torque reading or feedback to the user. These conventional power tools, that start from a stalled or locked motor, cannot use sensorless Field Oriented Control because sensorless Field Oriented Control requires accurate rotor position detection via phase currents and Back Electromotive Force. But since Back Electromotive Force cannot capture voltage signals from a stalled or locked motor, Back Electromotive Force cannot provide an accurate rotor position to the sensorless Field Oriented Control.

As alluded to in the above, there was previously no solution to starting in sensorless mode under a locked rotor condition where accurate torque reading is required.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention.

### SUMMARY

The present disclosure relates to a handheld power tool, comprising a housing, a motor disposed within the housing, the motor including at least one sensor, a dual mode motor controller including a first mode and a second mode, the first mode being sensored and the second mode being sensorless, a chuck operatively-coupled to the motor, a display mounted on a rear surface of the housing, said display being positioned opposite the chuck, and processing circuitry disposed within the housing, the processing circuitry being configured to control the dual mode motor controller based on a signal received from the display, wherein the processing circuitry generates a first estimation of rotor angle using the first mode, rotates a rotor of the motor based on the first estimation of the rotor angle using the first mode, determines a current torque value of the motor based on the first estimation of the rotor angle using the first mode, generates a second estimation of rotor angle using the second mode when the current torque value of the motor matches a predetermined torque value of the motor, and rotates the rotor of the motor based on the second estimation of the rotor angle using the second mode.

The present disclosure further relates to a method for controlling a handheld power tool, the handheld power tool comprising a housing, a motor disposed within the housing, the motor including at least one sensor, a dual mode motor controller including a first mode and a second mode, the first mode being sensored and the second mode being sensorless, a chuck operatively-coupled to the motor, a display mounted on a rear surface of the handheld power tool, said display being positioned opposite the chuck, and processing circuitry disposed within the housing, the processing circuitry configured to control the dual mode motor controller based on a signal received from the display, the method comprising, generating, via the processing circuitry, a first estimation of rotor angle using the first mode, rotating a rotor of the motor based on the first estimation of the rotor angle using the first mode, determining, via the processing circuitry, a current torque value of the motor based on the first estimation of the rotor angle using the first mode, generating, via the processing circuitry, a second estimation of rotor angle using the second mode when the current torque value of the motor matches a predetermined torque value of the motor, and rotating the rotor of the motor based on the second estimation of the rotor angle using the second mode.

The present disclosure further relates to a handheld power tool system, the system comprising, a housing, a motor disposed within the housing, the motor including at least one sensor, a dual mode motor controller including a first mode and a second mode, the first mode being sensored and the second mode being sensorless, a chuck operatively-coupled to the motor, a display mounted on a rear surface of the housing, said display being positioned opposite the chuck, and processing circuitry disposed within the housing, the processing circuitry being configured to control the dual mode motor controller based on a signal received from the display, wherein the processing circuitry generates a first estimation of rotor angle using the first mode, rotates a rotor of the motor based on the first estimation of the rotor angle using the first mode, determines a current torque value of the motor based on the first estimation of the rotor angle using the first mode, generates a second estimation of rotor angle using the second mode when the current torque value of the motor matches a predetermined torque value of the motor, and rotates the rotor of the motor based on the second estimation of the rotor angle using the second mode.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustration of a side view of a handheld power tool assembly, according to an exemplary embodiment of the present disclosure;

FIG. 2 is an illustration of a side view of a handheld power tool assembly, according to an exemplary embodiment of the present disclosure;

FIG. 3 is a schematic describing communicatively-coupled components of a handheld power tool, according to an exemplary embodiment of the present disclosure;

FIG. 4 is an illustration of an exploded view of a handheld power tool assembly, according to an exemplary embodiment of the present disclosure;

FIG. 5 is an illustration of a laser of a handheld power tool, according to an exemplary embodiment of the present disclosure;

FIG. 6A is an illustration of a display of a handheld power tool, according to an exemplary embodiment of the present disclosure;

FIG. 6B is an illustration of a display of a handheld power tool, according to an exemplary embodiment of the present disclosure;

FIG. 6C is an illustration of a display of a handheld power tool, according to an exemplary embodiment of the present disclosure;

FIG. 6D is an illustration of a display of a handheld power tool, according to an exemplary embodiment of the present disclosure;

FIG. 6E is an illustration of a display of a handheld power tool, according to an exemplary embodiment of the present disclosure;

FIG. 6F is an illustration of a display of a handheld power tool, according to an exemplary embodiment of the present disclosure;

FIG. 6G is an illustration of a display of a handheld power tool, according to an exemplary embodiment of the present disclosure;

FIG. 6H is an illustration of a display of a handheld power tool, according to an exemplary embodiment of the present disclosure;

FIG. 6I is an illustration of a display of a handheld power tool, according to an exemplary embodiment of the present disclosure;

FIG. 6J is an illustration of a display of a handheld power tool, according to an exemplary embodiment of the present disclosure;

FIG. 6K is an illustration of a display of a handheld power tool, according to an exemplary embodiment of the present disclosure;

FIG. 6L is an illustration of a display of a handheld power tool, according to an exemplary embodiment of the present disclosure;

FIG. 6M is an illustration of a display of a handheld power tool, according to an exemplary embodiment of the present disclosure;

FIG. 6N is an illustration of a display of a handheld power tool, according to an exemplary embodiment of the present disclosure;

FIG. 6O is an illustration of a display of a handheld power tool, according to an exemplary embodiment of the present disclosure;

FIG. 6P is an illustration of a display of a handheld power tool, according to an exemplary embodiment of the present disclosure;

FIG. 6Q is an illustration of a display of a handheld power tool, according to an exemplary embodiment of the present disclosure;

FIG. 6R is an illustration of a display of a handheld power tool, according to an exemplary embodiment of the present disclosure;

FIG. 6S is an illustration of a display of a handheld power tool, according to an exemplary embodiment of the present disclosure;

FIG. 6T is an illustration of a display of a handheld power tool, according to an exemplary embodiment of the present disclosure;

FIG. 6U is an illustration of a display of a handheld power tool, according to an exemplary embodiment of the present disclosure;

FIG. 6V is an illustration of a display of a handheld power tool, according to an exemplary embodiment of the present disclosure;

FIG. 6W is an illustration of a display of a handheld power tool, according to an exemplary embodiment of the present disclosure;

FIG. 6X is an illustration of a display of a handheld power tool, according to an exemplary embodiment of the present disclosure;

FIG. 6Y is an illustration of a display of a handheld power tool, according to an exemplary embodiment of the present disclosure;

FIG. 6Z is an illustration of a display of a handheld power tool, according to an exemplary embodiment of the present disclosure;

FIG. 6AA is an illustration of a display of a handheld power tool, according to an exemplary embodiment of the present disclosure;

FIG. 6AB is an illustration of a display of a handheld power tool, according to an exemplary embodiment of the present disclosure;

FIG. 7 is a schematic describing hardware of a handheld power tool, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “user” and “craftsman”, as well as the terms “users” and “craftsmen”, as used herein, should be considered interchangeable and are merely used to convey and end user of the invention. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

For a craftsman, the ability to set precise behavior of a handheld power tool while continuing to operate the handheld power tool is currently limited. To this end, early efforts have resulted in limited user control over behavior of a handheld power tool.

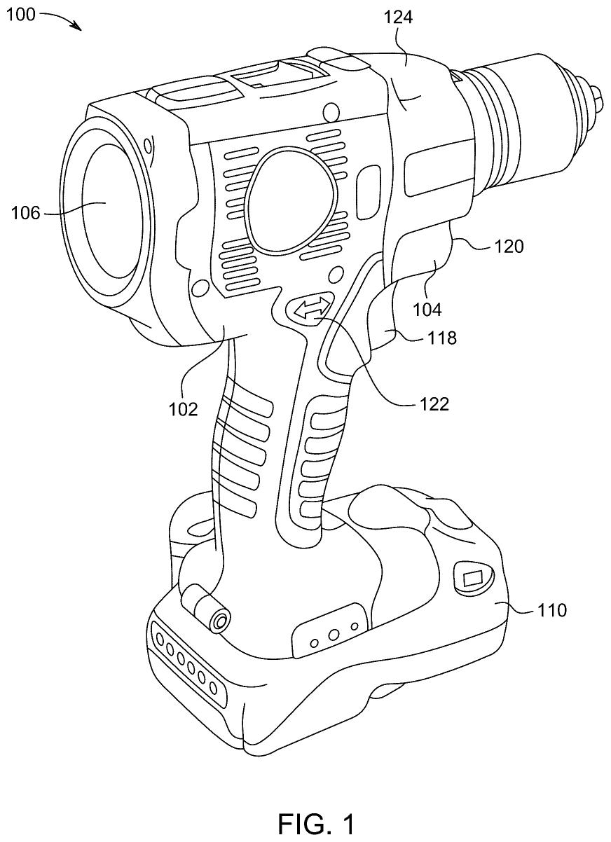

Accordingly, FIG. 1 is a handheld power tool assembly 100 including a handheld power tool 102, a laser 104, a display 106, and a housing 124. The handheld power tool 102 can be a drill, an impact driver, an impact gun, a torque driver, a vacuum, a pump, a saw, a crimper, or similar device used in any other electric motor-powered application. For illustrative purposes, and as shown in FIG. 1 in a non-limiting example, the handheld power tool 102 is a power drill.

According to an embodiment, the handheld power tool 102 includes, at least, a motor, a battery 110 that supplies power to the motor, and one or more printed circuit boards (PCBs). The motor includes a shaft coupled to a gearbox and a clamp such as, for example, a chuck, that allows for controlling a rotation of a tool during an operation. In an embodiment, the motor can be a brushless motor. In an embodiment, the handheld power tool 102 includes processing circuitry, including a motion controller, for controlling an action of the motor in response to a user interfacing with a trigger 118 of the handheld power tool 102. The trigger 118 can be coupled to the processing circuitry of the PCB, and the motion controller included in the PCB, and the handheld power tool 102. The trigger 118 can be interfaced with by the user allowing the user to control operation of the motor.

The above-described processing circuitry, described in greater detail below, can be implemented on the one or more PCBs. The one or more PCBs can be disposed within the housing of the handheld power tool 102. According to an embodiment, the one or more PCBs can be disposed within the handle of handheld power tool 102. In another embodiment, the one or more PCBs can be located remotely from the handheld power tool 102 and communicate with the handheld power tool 102 via included wireless communication circuitry, such as a Wi-Fi circuitry, a Bluetooth circuitry, or a Cellular circuitry. In an embodiment, the user can receive a call on the handheld power tool 102 via the Cellular circuitry or through personal phone communication between a user device and the handheld power tool 102.

The motion controller, described in greater detail below, can include a dual-mode motor control comprising a sensored mode implementing positioning sensors, such as Hall sensors disposed, for example, in the motor or the back of the motor, and a sensorless mode implementing a Field Oriented Control angle estimator. The Hall sensors can detect rotor position and can be installed, for example, at 60-degree increments. In an embodiment, using sensorless mode, the motion controller determines an angle of the rotor based on measured phase currents and voltages. It can be appreciated that it is beneficial to control the motor using the sensorless mode because the sensorless mode provides a more accurate angle of a rotor than the sensored mode which results in smoother torque production, feedback to the user, and more efficient control of the motor using sensorless mode than when using sensored mode. Additionally, it can be appreciated that in certain conditions, the sensorless mode does not provide an accurate angle of a rotor measurement, for example, when the motor is in a stalled condition. In an example, when the speed of the motor is low, the motion controller changes from sensorless mode to using the Hall sensors in sensored mode, and when the speed of the motor increases to a predetermined rate, the motion controller changes from sensored mode to sensorless mode. In an embodiment, the dual mode motor control allows the motor to start from a stalled position. In an embodiment, the dual mode motor control allows the motor to control a speed, torque limits, and angle positioning of the motor rotor.

In an embodiment, the dual mode motor control allows the user to implement different behaviors into the handheld power tool 102, such as setting a precise speed and torque limit of the rotor, setting an angle rotation of the rotor, setting an acceleration and deceleration of the rotor, setting parameters for sudden stops or instant reverse rotations of the rotor, setting parameters for antistripping in the event of fastening, setting parameters for antikickback of the rotor in the event of high torque tools, and other behaviors of handheld power tool applications via a touch interactive screen of the display 106. In an embodiment, the handheld power tool 102 can be configured to automatically stop or reverse based on receiving a signal from one or more sensors, for example cameras, infrared cameras, thermal cameras, or lasers, depending on user input parameters.

In an embodiment, the above mentioned motion controller, described in greater detail below, can calculate a torque of the motor based on phase currents, voltages, a bus voltage, and a selected gear ratio. In an embodiment, a dynamometer creates a torque calibration table to calculate the torque of the motor. The handheld power tool 102 can be set to a driver mode with an anti-stripping mode enabled, for example, the motion controller determines an increase in torque level during an operation where a screw is driven into a work piece. Additionally, if the motion controller detects a sudden decrease in torque level, it can be appreciated that this decrease in torque level may be the result of, for example, a driver bit losing engagement with a screw head, or screw threads starting to strip the work piece. In an embodiment, the motion controller can detect stripping or breaking of a screw or a bolt and the motion controller can implement stopping, decelerating, or reversing when a decrease in torque level is detected during operation of the handheld power tool 102 to avoid stripping or breaking of the screw or the bolt, damaging a work piece, damaging a tool, or bodily harm to the user. The user can input desired torque values via the touch interactive screen of the display 106 depending on a desired sensitivity level for anti-stripping operation of the handheld power tool 102. In an example, during torquing operation, the display 106 can show an animation related to the motion of the rotor of the motor or shaft of the handheld power tool 102.

In an embodiment, the above mentioned motion controller, described in greater detail below, can calculate a torque of the motor based on phase currents, voltages, a bus voltage, and a selected gear ratio. In an embodiment, a dynamometer creates a torque calibration table to calculate the torque of the motor. The handheld power tool 102 can be set to a torque-halting mode in which the motion controller stops the motor when a predetermined torque setting is reached, for example, the predetermined torque setting is a user input torque value. Additionally, the handheld power tool 102 can be set to a torque-stalling mode in which the motion controller prevents the motor from exceeding the predetermined torque setting and will maintain a constant torque level during operation as the user continues to hold the trigger 118, the predetermined torque setting is a user input torque value.

In an embodiment, the motion controller can initiate an automated tapping function in which the Field-Oriented Control sensorless mode allows for high-fidelity control of the motor where the angle of the motor is detected in real time. It can be appreciated when tapping holes, in order to prevent breakage of the tap it is recommended to periodically back out the bit after advancing. Using the automated tapping function of the handheld power tool 102, the motion controller can, for example, back out the bit after each full rotation of advancement into the work piece. This automated tapping function can be performed in quick succession to protect the tapping bit by, for example, additionally imposing an optional torque limit based on a desired tap size of the user.

In an embodiment, the display 106 can receive a user input for a desired automated bolt torquing operation. During a tightening or un-tightening operation, the handheld power tool 102 can automatically accelerate, decelerate, stop, or reverse based on a user input torque value. In an embodiment, the sensorless mode implementing a Field Oriented Control angle estimator can receive a torque value from the user and perform an operation with a predetermined control speed (RPM) and torque of the motor based on the user input torque value. In an embodiment, the motion controller can receive data from and send data to the main controller during an operation, for example, the data can include torque data accurately measured by the sensorless mode implementing a Field Oriented Control angle estimator and send the torque data to the main controller during an operation of the handheld power tool 102. In an embodiment, the dual mode motor control can switch from sensored mode to sensorless mode implementing Field-Oriented Control and from sensorless mode implementing Field-Oriented Control to sensored mode, for example, when the motor cannot rotate or when a torque value cannot be read. In an embodiment, the handheld power tool 102 includes a pump, in an example, when the pump is under load, the main controller will start an operation of the handheld power tool 102 using the sensorless mode implementing Field-Oriented Control.

In an embodiment, the sensorless mode with Field-Oriented Control can detect an angle positioning of the motor in real time, allowing the user to set a desired angle value to tighten the fastener via the display 106. The rotor of the motor can spin to the angle value input by the user and automatically stop operation when the rotor of the motor reaches the angle value input by the user. In an embodiment, the sensorless mode implementing Field-Oriented Control can estimate a torque value of the motor from phase currents and voltages and the sensorless mode implementing Field-Oriented Control can stop, start, or reverse the rotor of the motor automatically or by user input via the display 106. In an embodiment, the sensorless mode implementing Field-Oriented Control can detect a speed of rotation and a direction of rotation and maintain speed, accelerate, decelerate, or reverse the rotor of the motor automatically or by user input via the display 106. In an embodiment, the sensorless mode implementing Field-Oriented Control can automatically brake the operation of the motor by applying a negative torque into the motor.

According to an embodiment, the display 106 of the handheld power tool assembly 100 can be coupled to one or more PCBs of the handheld power tool 102 and can be powered by the battery 110. The display 106 can be generally circular and can be disposed on the rear surface of the handheld power tool 102 or on a docking attachment. In particular, the display 106 can be disposed such that the display 106 is in a position facing the user and visible to the user during operation of the handheld power tool 102. In an embodiment, the display 106 is a touch interactive screen such as an active-matrix organic light-emitting diode with an integrated digitizer. To enable user interaction with the display 106, processing circuitry, such as the above-referenced processing circuitry integrated with the one or more PCBs, can control the display 106. In an embodiment, the display 106 is a monochrome or colored display. In an embodiment, the display 106 can support dynamic graphics and video streaming via the included wireless communication circuitry of the handheld power tool 102.

According to an embodiment, the handheld tool assembly 100 can include a sound controller for controlling a speaker and a microphone disposed inside the housing of the handheld power tool 102. The speaker can generate audio for communication with the user. The microphone can, for example, receive voice commands from the user. In turn, in an embodiment, the speaker in combination with the microphone can enable the user to control the handheld power tool assembly 100, and the display 106 therein, with voice commands. In an embodiment, the handheld power tool assembly 100 can include a haptic motor that emits vibration feedback to the user, for example, when the speaker produces an audio signal, to generate sounds, or in any other situation where a vibration is useful.

According to an embodiment, and as shown in FIG. 1, the laser 104 can be disposed immediately above the trigger 118 and such that a laser emitted from the laser 104 is located on a plane that is parallel to a plane of a rotational axis of the chuck. In an embodiment, the laser 104 can include or more laser diodes and one or more laser receivers or laser detectors. The laser diodes and the laser receivers or laser detectors can be coupled to the processing circuitry integrated with the PCBs of the handheld power tool 102 to emit laser beams from the laser diodes or to receive laser beams with the laser receivers or laser detectors. According to an embodiment, the laser 104 can be configured to transmit a signal, via the processing circuitry integrated within the one or more PCBs of the handheld power tool 102, to stop or start the motor.

According to an embodiment, the laser 104 can include a laser measuring circuit capable of measuring a user input drill or tap depth. The user can finely adjust a desired drill or tap depth via the display 106. It can be appreciated that various implementations of the laser measuring circuit can be implemented in the laser 104, for example, the laser measuring circuit can receive a desired depth from the user via the touch interactive screen of the display 106, and the display 106 can show synchronized movement of the graphics related to the movement of the handheld power tool 102. In an embodiment, the handheld power tool 102 can perform an operation based on the desired depth of the user, for example, the handheld power tool 102 can stop the motor automatically when the desired depth of the user is measured by the laser measuring circuit. In an embodiment, the user can press the trigger 118 to set up a “zero” or “origin” value of the laser beam of the laser 104.

According to an embodiment, the handheld power tool 102 can include one or more cameras, such as infrared cameras, thermal cameras, or any other cameras suitable for use with handheld power tool applications. The one or more cameras can be disposed parallel to the plane of the rotational axis of the chuck. To this end, the one or more cameras can be configured to detect various parameters, such as a size, location, or temperature, of a drill bit, a fastener bit, a screw, or a surface exterior to the handheld power tool 102. In an example, the display 106 can show the user the above-mentioned various parameters detected by the one or more cameras via a graphical representation. In an embodiment, the laser measuring circuit can be exploited to measure a distance to the surface exterior to the handheld power tool 102 via the laser beam of the laser measuring circuit in tandem with the one or more cameras detecting the above-mentioned various parameters.

According to an embodiment, the handheld power tool 102 can include a flashlight 120. The flashlight 120 can be configured to be controlled by the above-described processing circuitry of the handheld power tool such that the flashlight 120 is activated prior to and during operation of the handheld power tool 102 or, for example, such that the flashlight 120 is activated based on an actuation of the trigger 118 by the user. In an embodiment, the flashlight 120 can be activated by the microphone receiving a voice command of the user. In an embodiment, the flashlight 120 can be activated by user input via the touch interactive screen of the display 106.

According to an embodiment, the handheld power tool 102 includes a forward/reverse button 122 disposed on a surface of the handheld power tool 102 immediately rearward of the laser 104. The forward/reverse button 122 is communicatively-coupled to the above-mentioned processing circuitry allowing the user to program the forward/reverse button 122 depending on a desired behavior of the forward/reverse button 122, such as actuation of the forward/reverse button 122 requiring a short press, a long press, one press, multiple presses, or any other combination of inputs. In an embodiment, one or more forward/reverse buttons 122 are included on opposing sides of the handheld power tool 102 for allowing the one or more forward/reverse buttons 122 to be programmed based on a right hand or left hand preference of the user. In an embodiment, the user can input a user preference for the behavior of the forward/reverse button 122 by way of the touch interactive screen of the display 106.

In an embodiment, a handheld power tool assembly can be modified or retrofitted with, for example, additional lasers, infrared cameras, cameras, thermal cameras, mounting rails for various attachments such as Picatinny rails, and other parts related to power tool applications.

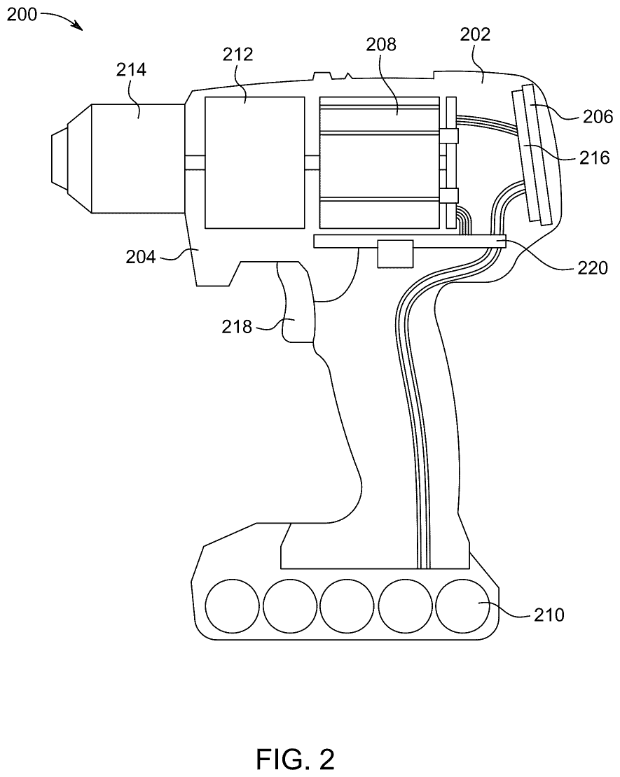

FIG. 2 is a handheld power tool assembly 200 including a handheld power tool 202. The handheld power tool 202 includes, at least, a laser 204, a display 206 for implementing different behaviors into the handheld power tool 202, a motor 208, and a battery 210 that supplies power to the motor 208. The motor 208 includes a shaft coupled to a gearbox 212 and a clamp such as, for example, a chuck 214, that allows for controlling a rotation of a tool during an operation. In an embodiment, the handheld power tool 202 includes processing circuitry, including a motion controller 216, for controlling an action of the motor 208 in response to a user interfacing with a trigger 218 of the handheld power tool 202. In an embodiment, the dual-mode motor control 220 being comprised of a sensored mode and a sensorless mode. In an embodiment, the motion controller operates to automatically switch between the sensored mode and the sensorless mode of the dual mode motor control 220. In an embodiment, the motion controller 216 controls a dual system motor control, the dual system motor control being comprised of a sensored motor control and a sensorless motor control. In an embodiment, the motion controller operates to automatically switch between the sensored motor control and the sensorless motor control of the dual system motor control.

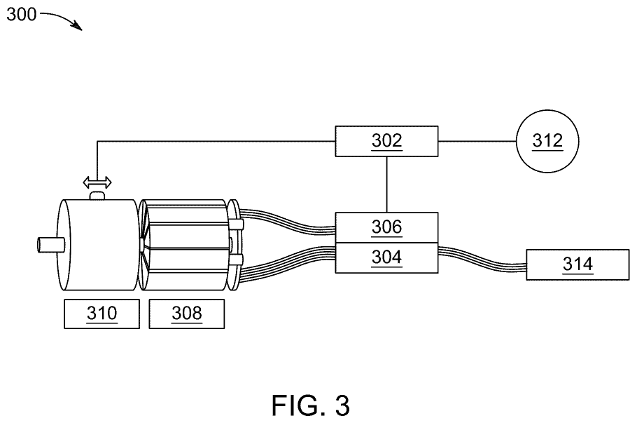

FIG. 3 is a schematic describing communicatively-coupled components of a handheld power tool. According to an embodiment, the communicatively-coupled components include, at least, a motion controller 302 communicatively-coupled to and configured to control a dual mode motor control, the dual mode motor control communicatively-coupled to and configured to control a motor 308, a gearbox 310 coupled to the motor 308 via a shaft of the motor the gearbox 310 receiving rotational power from the motor 308, a display 312 communicatively-coupled to the motion controller 302 wherein the display 312 is configured to receive user input and control the motion controller 302 via the user input, and a battery 314 communicatively-coupled to the dual mode motor control for powering the dual mode motor control. In an embodiment, the display 312 comprises a touch interactive screen.

The dual mode motor control comprises a sensored mode 304 and a sensorless mode 306 implementing a Field-Oriented Control (FOC) angle estimator.

The dual mode motor control in sensored mode 304, described in greater detail below, receives a signal indicating a desired speed input from the motion controller 302, the motion controller 302 receives the signal indicating the desired speed input from, for example, the display 312 or a trigger of the handheld power tool. The dual mode motor control in sensored mode 304 receives DC power from a battery of the handheld power tool and uses included electronic switches, such as MOSFETs, to convert the DC power of the battery into three-phase AC current to control a speed, a direction, and a torque of the motor 308 via Pulse Width Modulation (PWM). The dual mode motor control in sensored mode 304 includes sensors, such as Hall sensors disposed in the motor, for detecting parameters of the motor 308, including, for example, a position of the rotor of the motor 308, the speed of the motor 308 (RPM), the torque of the motor 308, the direction of rotation of the motor 308, and other parameters of the motor 308.

The dual mode motor control in sensorless mode 306, described in greater detail below, detects three-phase stator currents of the motor 308 and defines the stator currents as two orthogonal components, a first orthogonal component defines a magnetic flux of the motor 308 and a second orthogonal component defines a torque of the motor 308. The dual mode motor control in sensorless mode 306 calculates current component references based on the magnetic flux of the motor 308 reference and the torque of the motor 308 reference and generates a magnetic flux component of the motor 308 and a torque component of the motor 308. The torque component of the motor 308 is oriented perpendicular to a plane of the rotor to control the torque of the motor 308, and the magnetic flux component of the motor 308 is oriented parallel to the plane of the rotor.

In an embodiment, the dual mode motor control further comprises a third mode, such as a hybrid mode. In an embodiment, the hybrid mode uses less than the total number of Hall sensors disposed in the motor to detect rotor position, and the less than the total number of Hall sensors used can be used, for example, at 60-degree increments, at 90-degree increments, or at 12-degree increments. In an embodiment, the hybrid mode both uses less than the total number of Hall sensors disposed in the motor and implements a Field Oriented Control angle estimator.

The motion controller 302, described in greater detail below, controls the dual mode motor control by transmitting a signal that determines whether to operate the dual mode motor control in sensored mode 304 and whether to operate the dual mode motor control in sensorless mode 306. In an embodiment, the motion controller 302 automatically transmits a signal to operate the dual mode motor control in sensored mode 304, for example, when the motor 308 is in a stalled condition, when the torque of the motor cannot be detected by the dual mode motor control in sensorless mode 306, when the dual mode motor control in sensorless mode 306 cannot detect an accurate estimate of an angle of the rotor via Back Electromotive Force (back-EMF), when the speed of the motor 308 is low such as between 0 percent and 10 percent of a maximum RPM of the motor 308, and other conditions where it is beneficial to operate the dual mode motor control in sensored mode 304. In an embodiment, the motion controller 302 automatically transmits a signal to operate the dual mode motor control in sensorless mode 306, for example, when the speed of the motor 308 is not low, such as when the speed of the motor 308 is greater than 10 percent of the maximum RPM of the motor 308.

According to an embodiment, the motion controller 302 automatically switches between the dual mode motor control in sensored mode 304 and the dual mode motor control in sensorless mode 306 based on a condition based on a user input via the display 312, the condition being, for example, a torque value of the motor 308 being reached, a speed value of the motor 308 being reached, an angle value of the rotor being detected, detection of stripping of a screw or drill bit, a time having elapsed, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications.

According to an embodiment, the motion controller 302 automatically switches between the dual mode motor control in sensored mode 304, in sensorless mode 306 and in hybrid mode based on a condition based on a user input via the display 312, the condition being, for example, a torque value of the motor 308 being reached, a speed value of the motor 308 being reached, an angle value of the rotor being detected, detection of stripping of a screw or drill bit, a time having elapsed, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications.

In an embodiment, the motion controller 302 switches between the dual mode motor control in sensored mode 304 and the dual mode motor control in sensorless mode 306 based on a combination of two or more conditions based on user input via the display 312, the combination of conditions being, for example, a torque value of the motor 308 and a speed value of the motor 308 can be used together such that the dual mode motor control switches from sensored mode 304 to sensorless mode 306 when both the torque value of the motor 308 and the speed value of the motor 308 reach a predetermined value. In an embodiment, the dual mode motor control switches from sensorless mode 306 to sensored mode 304 when both the torque value of the motor 308 and the speed value of the motor 308 reach a predetermined value. In an embodiment, the dual mode motor control switches from sensored mode 304 to sensorless mode 306 when both the torque value of the motor 308 and the speed value of the motor 308 reach a first predetermined value and the dual mode motor control switches from sensorless mode 306 to sensored mode 304 when both the torque value of the motor 308 and the speed value of the motor 308 reach a second predetermined value; a switch between modes can occur based on both the torque value of the motor 308 and the speed value of the motor 308 reaching a third predetermined value, or more than three predetermined values. In an embodiment, the above described switch can occur between the sensored mode 304 and the hybrid mode or between the sensorless mode 306 and the hybrid mode.

In an embodiment, the motion controller 302 switches between the dual mode motor control in sensored mode 304 and the dual mode motor control in sensorless mode 306 based on a combination of two or more conditions based on user input via the display 312, the combination of conditions being, for example, a torque value of the motor 308 and an angle value of the rotor can be used together such that the dual mode motor control switches from sensored mode 304 to sensorless mode 306 when both the torque value of the motor 308 and the angle value of the rotor reach a predetermined value. In an embodiment, the dual mode motor control switches from sensorless mode 306 to sensored mode 304 when both the torque value of the motor 308 and the angle value of the rotor reach a predetermined value. In an embodiment, the dual mode motor control switches from sensored mode 304 to sensorless mode 306 when both the torque value of the motor 308 and the angle value of the rotor reach a first predetermined value and the dual mode motor control switches from sensorless mode 306 to sensored mode 304 when both the torque value of the motor 308 and the angle value of the rotor reach a second predetermined value; a switch between modes can occur based on both the torque value of the motor 308 and the angle value of the rotor reaching a third predetermined value, or more than three predetermined values. In an embodiment, the above described switch can occur between the sensored mode 304 and the hybrid mode or between the sensorless mode 306 and the hybrid mode.

In an embodiment, the motion controller 302 switches between the dual mode motor control in sensored mode 304 and the dual mode motor control in sensorless mode 306 based on a combination of two or more conditions based on user input via the display 312, the combination of conditions being, for example, an angle value of the rotor and a speed value of the motor 308 can be used together such that the dual mode motor control switches from sensored mode 304 to sensorless mode 306 when both the angle value of the rotor and the speed value of the motor 308 reach a predetermined value. In an embodiment, the dual mode motor control switches from sensorless mode 306 to sensored mode 304 when both the angle value of the rotor and the speed value of the motor 308 reach a predetermined value. In an embodiment, the dual mode motor control switches from sensored mode 304 to sensorless mode 306 when both the angle value of the rotor and the speed value of the motor 308 reach a first predetermined value and the dual mode motor control switches from sensorless mode 306 to sensored mode 304 when both the angle value of the rotor and the speed value of the motor 308 reach a second predetermined value; a switch between modes can occur based on both the angle value of the rotor and the speed value of the motor 308 reaching a third predetermined value, or more than three predetermined values. In an embodiment, the above described switch can occur between the sensored mode 304 and the hybrid mode or between the sensorless mode 306 and the hybrid mode.

In an embodiment, the motion controller 302 switches between the dual mode motor control in sensored mode 304 and the dual mode motor control in sensorless mode 306 based on a combination of two or more conditions based on user input via the display 312, a first condition of the combination of conditions can be, for example, a torque value of the motor 308, a speed value of the motor 308, an angle value of the rotor, detection of stripping of a screw or drill bit, a predetermined time, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications, a second condition of the combination of conditions can be, for example, a torque value of the motor 308, a speed value of the motor 308, an angle value of the rotor, detection of stripping of a screw or drill bit, a predetermined time, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications, and an n-th condition of the combination of conditions can be, for example, a torque value of the motor 308, a speed value of the motor 308, an angle value of the rotor, detection of stripping of a screw or drill bit, a predetermined time, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications. The first condition of the combination of conditions and the second condition of the combination of conditions can be used together such that the dual mode motor control switches from sensored mode 304 to sensorless mode 306 when both the first condition and the second condition are satisfied. In an embodiment, the dual mode motor control switches from sensorless mode 306 to sensored mode 304 when both the first condition and the second condition are satisfied. In an embodiment, the dual mode motor control switches from sensored mode 304 to sensorless mode 306 when both the first condition and the second condition are satisfied for a first time, and the dual mode motor control switches from sensorless mode 306 to sensored mode 304 when both the first condition and the second condition are satisfied for a second time; a switch between modes can occur based on both the first condition and the second condition being satisfied for a third time, or on more than three occasions. In an embodiment, the switch between modes as described in the above embodiments can occur based on the first condition, the second condition, and the n-th condition being met, such that the n-th condition represents a third condition, a fourth condition, or any number of conditions in addition to the first condition and the second condition. In an embodiment, the above described switch can occur between the sensored mode 304 and the hybrid mode or between the sensorless mode 306 and the hybrid mode.

In an embodiment, the motion controller 302 switches between the dual mode motor control in sensored mode 304 and the dual mode motor control in sensorless mode 306 based on a combination of two or more conditions based on user input via the display 312, a first condition of the combination of conditions can be, for example, a torque value of the motor 308, a speed value of the motor 308, an angle value of the rotor, detection of stripping of a screw or drill bit, a predetermined time, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications, and a second condition of the combination of conditions can be, for example, a torque value of the motor 308, a speed value of the motor 308, an angle value of the rotor, detection of stripping of a screw or drill bit, a predetermined time, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications. The first condition of the combination of conditions and the second condition of the combination of conditions can be used together such that the dual mode motor control switches from sensored mode 304 to sensorless mode 306 when both the first condition and the second condition are satisfied. In an embodiment, the dual mode motor control switches from sensorless mode 306 to sensored mode 304 when both the first condition and the second condition are satisfied. In an embodiment, the dual mode motor control switches from sensored mode 304 to sensorless mode 306 when both the first condition and the second condition are satisfied for a first time, and the dual mode motor control switches from sensorless mode 306 to sensored mode 304 when both the first condition and the second condition are satisfied for a second time; a switch between modes can occur based on both the first condition and the second condition being satisfied for a third time, or on more than three occasions.

In an embodiment, the motion controller 302 switches from the dual mode motor control in sensored mode 304 to the dual mode motor control in sensorless mode 306 based on a first condition being satisfied and the motion controller 302 switches from the dual mode motor control in sensorless mode 306 to the dual mode motor control in sensored mode 304 based on a second condition being satisfied, in which the first condition is a different condition than the second condition, for example, the first condition is satisfied when a torque value of the motor 308 reaches a predetermined value and the second condition is satisfied when an angle value of the rotor reaches a predetermined value; in another example, the first condition and the second condition can be any of the conditions discussed above.

According to an embodiment, the motion controller 302 transmits a signal to the dual mode motor control to switch between the sensored mode 304 and the sensorless mode 306 gradually by initiating the switch between the sensored mode 304 and the sensorless mode 306, for example, at a predetermined speed of the motor 308 (RPM of the motor), at a predetermined torque of the motor 308, at a predetermined position of the rotor of the motor 308 detected via phase currents and back-EMF, at a predetermined estimated percent error of a back-EMF signal, or when other conditions are met where it is beneficial to begin a gradual switch between the sensored mode 304 and the sensorless mode 306. The gradual switch between the sensored mode 304 and the sensorless mode 306 can be completed, for example, at a predetermined speed value of the motor 308 (RPM of the motor), at a predetermined torque value of the motor 308, at a predetermined position of the rotor of the motor 308 detected via phase currents and back-EMF, at a predetermined estimated percent error of a back-EMF signal, or when other conditions are met where it is beneficial to begin a gradual switch between the sensored mode 304 and the sensorless mode 306.

In an embodiment, the gradual switch between sensored mode 304 and sensorless mode 306 occurs based on a combination of two or more conditions being satisfied, such as both reaching a predetermined torque value of the motor 308 and reaching a predetermined position of the rotor of the motor 308 detected via phase currents and back-EMF. In an embodiment, the gradual switch between sensorless mode 306 and sensored mode 304 occurs based on a combination of two or more conditions being satisfied, such as both reaching a predetermined torque value of the motor 308 and reaching a predetermined speed value of the motor 308. In an embodiment, the combination of two or more conditions required to switch the mode of the dual mode motor control can be any of the conditions previously discussed.

According to an embodiment, the motion controller 302 transmits a signal to the dual mode motor control to gradually switch between the sensored mode 304 and the sensorless mode 306 where when the switch is initiated, the sensored mode 304 is the sole mode in use by the dual mode motor control until the gradual switch is completed, and where when the switch is completed, the sensorless mode 306 is the sole mode in use by the dual mode motor control.

According to an embodiment, the motion controller 302 transmits a signal to the dual mode motor control to gradually switch between the sensored mode 304 and the sensorless mode 306 where when the switch is initiated, the sensorless mode 306 is the sole mode in use by the dual mode motor control until the gradual switch is completed, and where when the switch is completed, the sensored mode 304 is the sole mode in use by the dual mode motor control. In an embodiment, the above described gradually occurring switch can occur between the sensored mode 304 and the hybrid mode or between the sensorless mode 306 and the hybrid mode.

According to an embodiment, the motion controller 302 transmits a signal to the dual mode motor control to switch between the sensored mode 304 and the sensorless mode 306 based on a user input via the display 312.

According to an embodiment, the dual mode motor control switches between the sensored mode 304, the sensorless mode 306, and the hybrid mode based on a user input via the display 312. In an embodiment, after the switching modes based on the user input via the display 312, the dual mode motor control switches between the sensored mode 304, the sensorless mode 306, and the hybrid mode based on one or more conditions being satisfied, for example, a torque value of the motor 308, a speed value of the motor 308, an angle value of the rotor, detection of stripping of a screw or drill bit, a predetermined time, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications.

According to an embodiment, the dual mode motor control switches between the sensored mode 304, the sensorless mode 306, and the hybrid mode based on one or more conditions being satisfied, for example, a torque value of the motor 308, a speed value of the motor 308, an angle value of the rotor, detection of stripping of a screw or drill bit, a predetermined time, a detection of a kickback of the motor 308, receiving a signal of an IMU included in the handheld power tool, receiving a signal of a sensor included in the handheld power tool, an actuation of a trigger of the handheld power tool, or any other user desired condition related to power tool applications. In an embodiment, after the switching mode based on the one or more conditions being satisfied, the dual mode motor control switches between the sensored mode 304, the sensorless mode 306, and the hybrid mode based on a user input via the display 312.

According to an embodiment, the dual mode motor control switching between the sensored mode 304, the sensorless mode 306, and the hybrid mode can be a gradual switch as discussed above, and can be, for example, based on satisfying one or more conditions. In an embodiment, after the switching modes, the dual mode motor control can switch between the sensored mode 304, the sensorless mode 306, and the hybrid mode based on a user input via the display 312.

According to an embodiment, the dual mode motor control can switch between the sensored mode 304, the sensorless mode 306, and the hybrid mode based on a user input via the display 312, and after the switching modes, the dual mode motor control can switch between the sensored mode 304, the sensorless mode 306, and the hybrid mode via a gradual switch as discussed above.

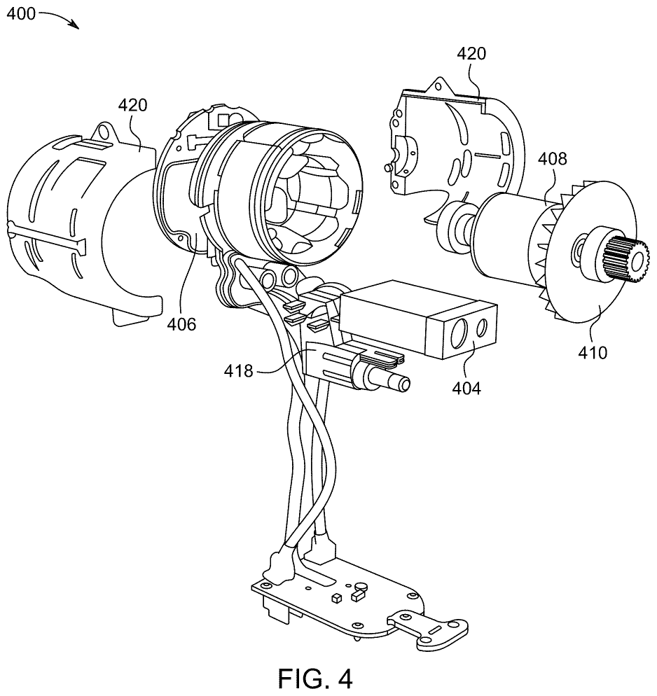

FIG. 4 provides an exploded view of a handheld power tool assembly 400 including a handheld power tool. The handheld power tool includes, at least, a laser 404, a display 406 for implementing different behaviors into the handheld power tool, a motor 408, a rotor 410 of the motor 408, and a housing 420. In an embodiment, the handheld power tool includes processing circuitry, including a motion controller, for controlling an action of the motor 408 in response to a user interfacing with a trigger 418 of the handheld power tool. The trigger 418 can be coupled to the processing circuitry, the motion controller, and the handheld power tool. The trigger 418 can be interfaced with by the user allowing the user to control operation of the motor 408.

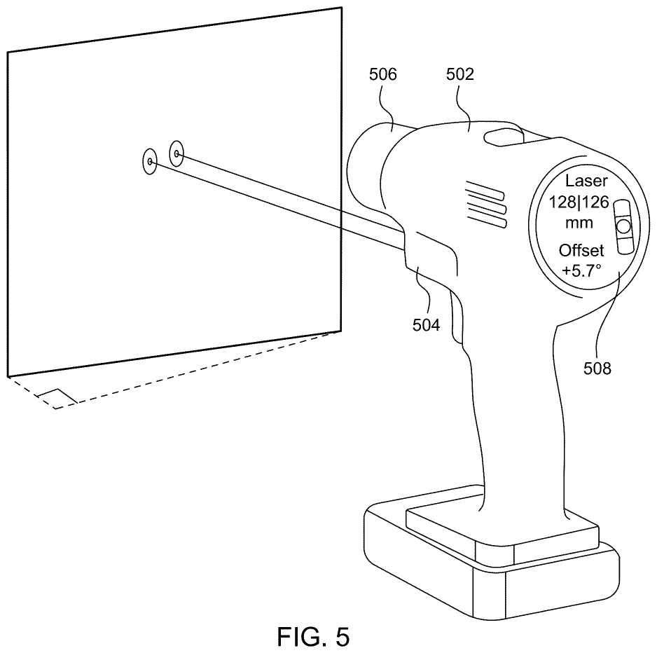

FIG. 5 provides an illustration of a laser of the handheld power tool assembly 200 during an exemplary operation.

According to an embodiment, and as shown in FIG. 5, one or more laser measuring circuit 504 can be disposed in the same position or in different positions within the handheld power tool 502 to provide the user with additional functionality. In an embodiment, two or more laser measuring circuits 504 can be disposed parallel to one another and parallel to the plane of the rotational axis of the chuck 506. To this end, the two or more laser measuring circuits 504 can measure an angle of a surface exterior to the handheld power tool assembly 500 and the display 508 can show the laser measurements of the two or more laser measuring circuits 504 to the user for drilling plumb.

Exploited in tandem with the laser measuring circuit 504, according to an embodiment, the handheld power tool assembly 500 can include a three-axis inertial measurement unit communicatively-coupled with processing circuitry integrated with the PCB of the handheld power tool 502 to determine an orientation of the handheld power tool 502 in relation to a level position. In an example, the data generated by the three-axis inertial measurement unit can be shown on the display 508 by way of a dynamic level graphic, for example, the dynamic level graphic indicates a reference angle between an axis of the handheld power tool 502 and a level position relative to a level plane of the ground.

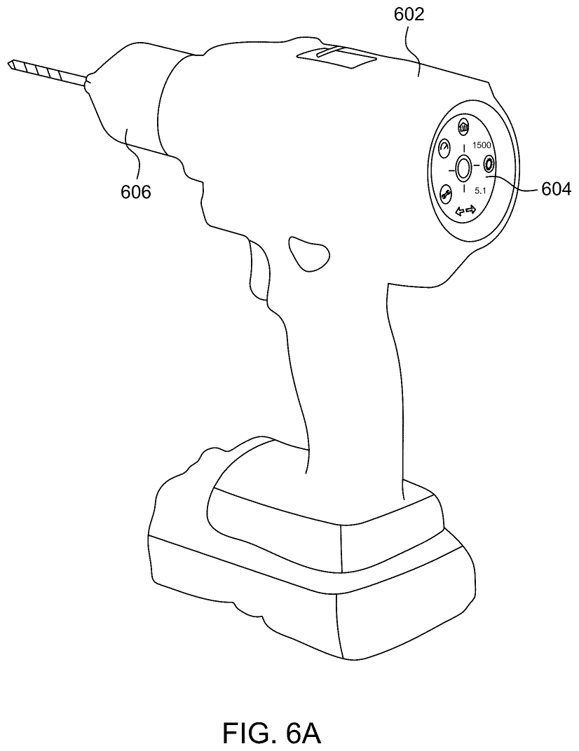

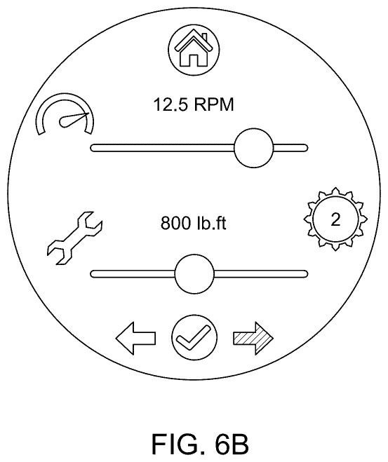

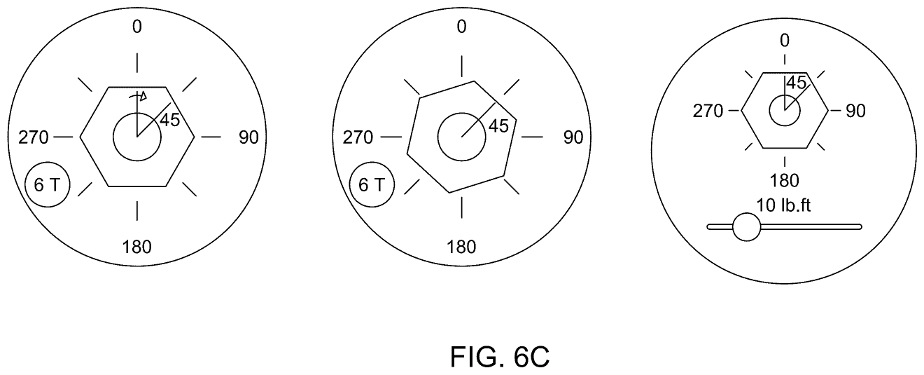

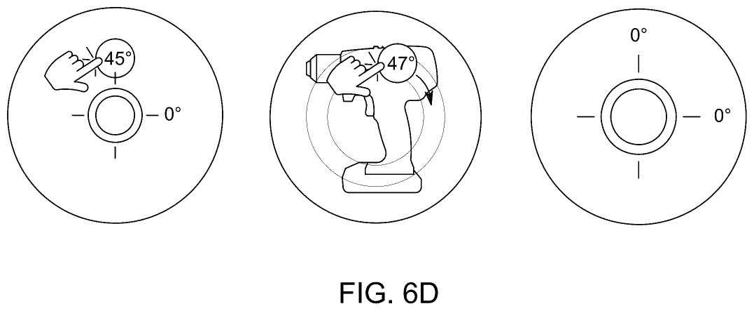

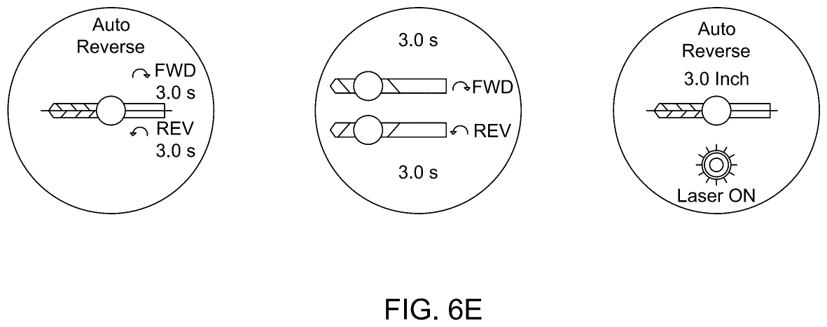

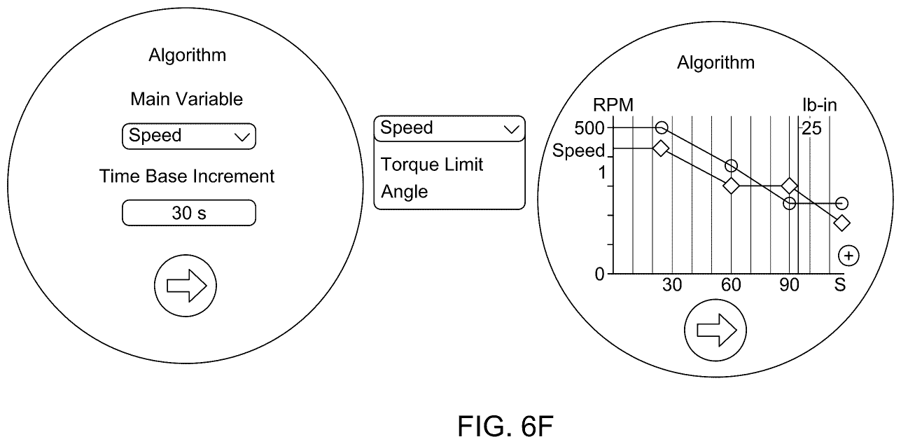

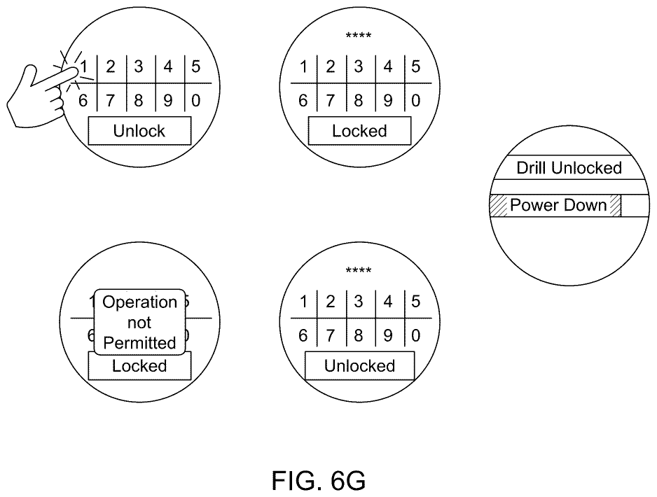

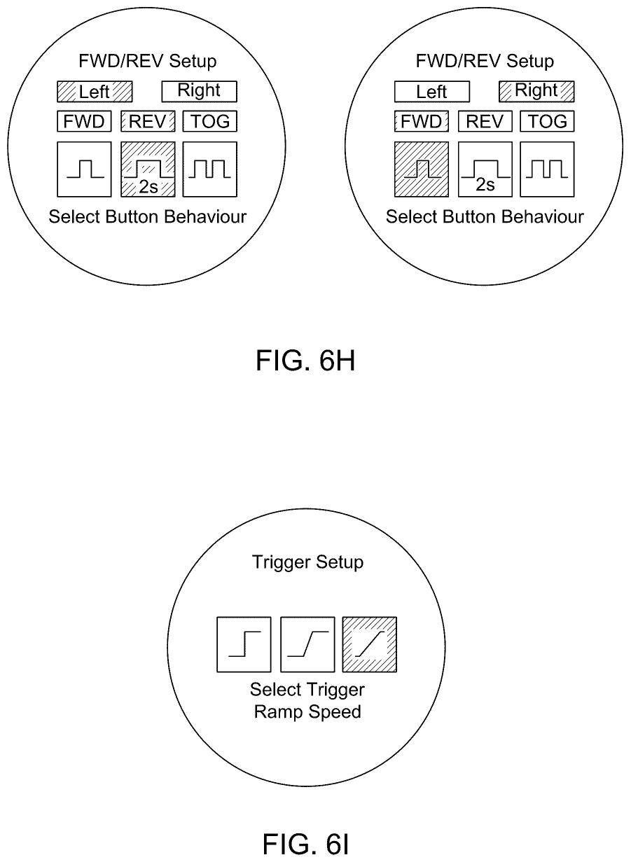

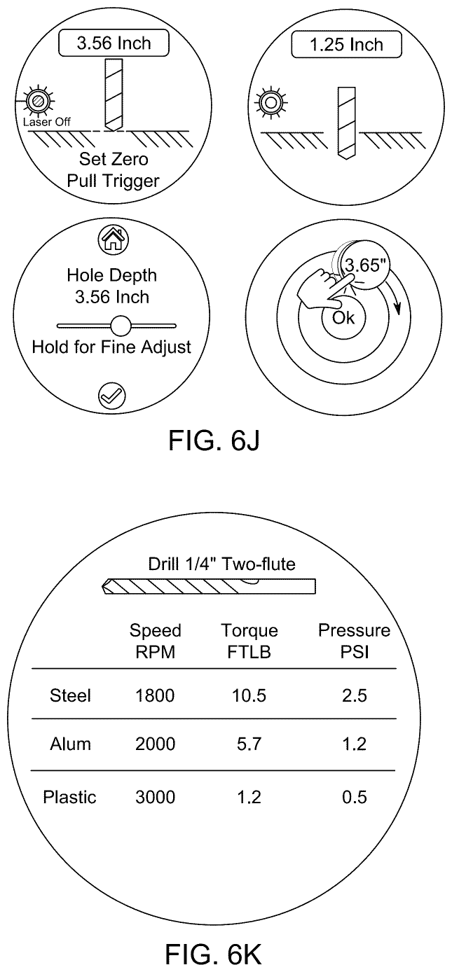

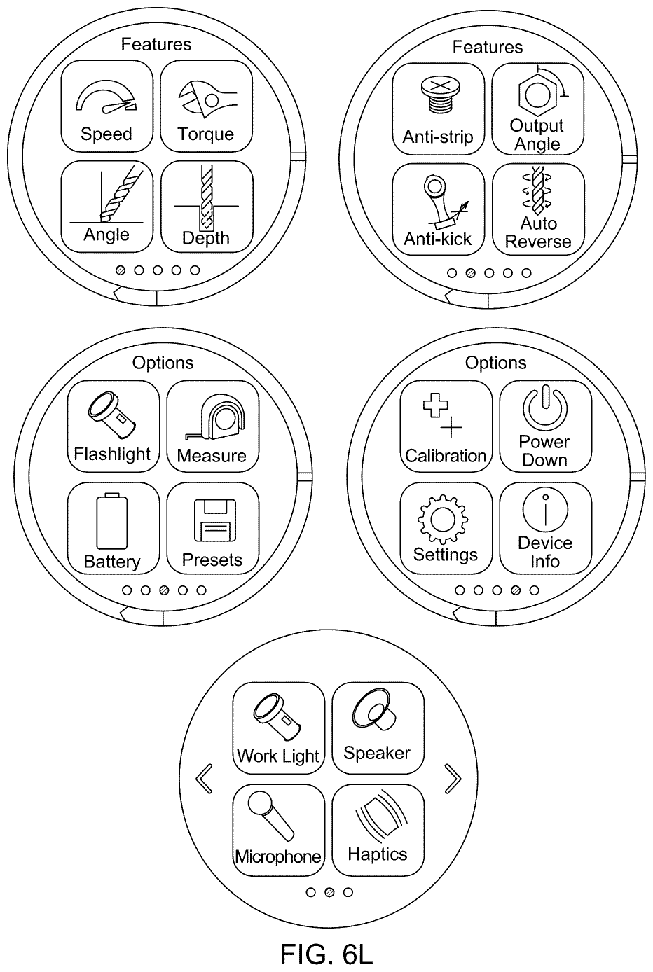

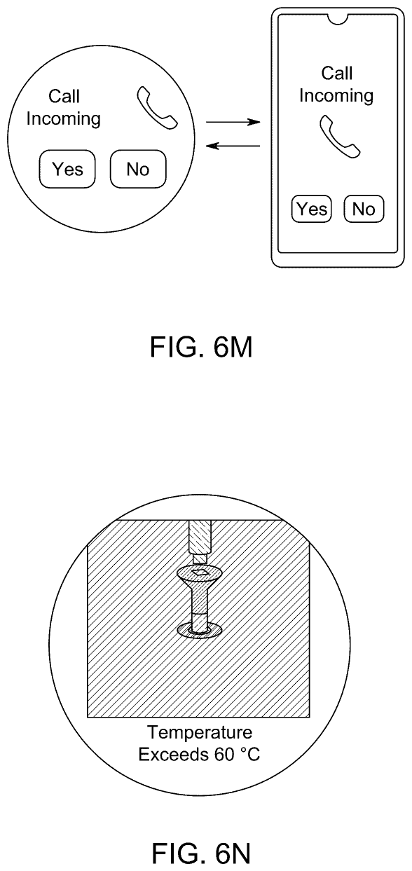

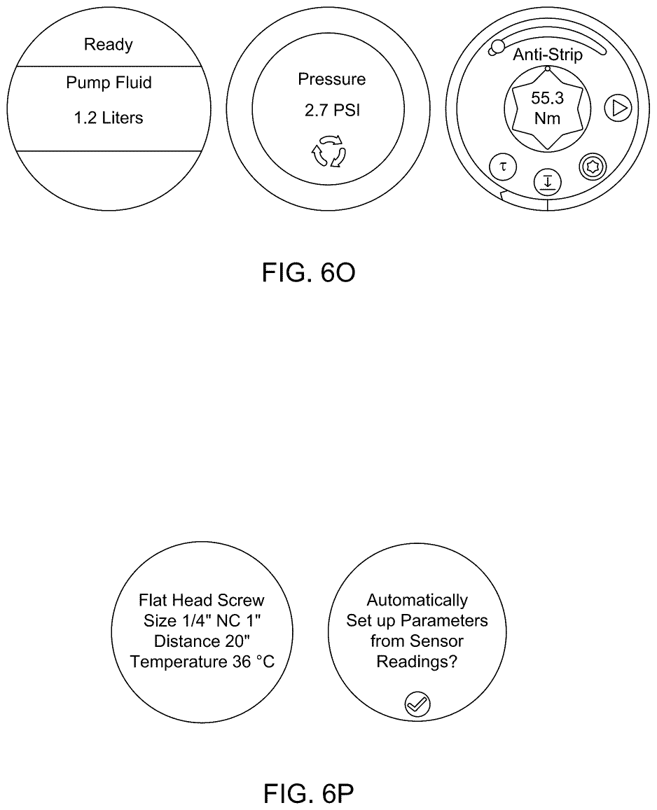

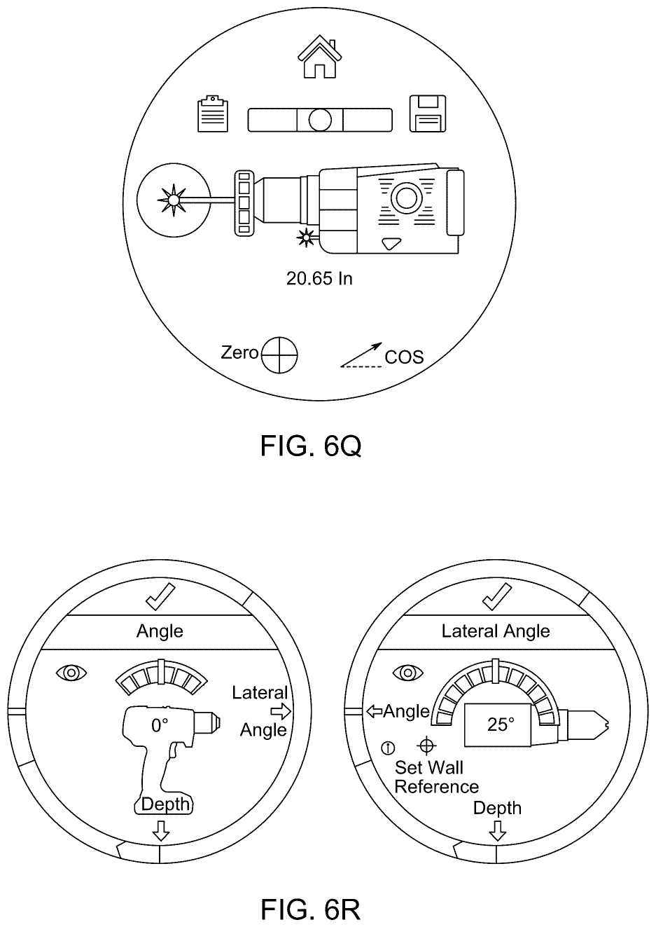

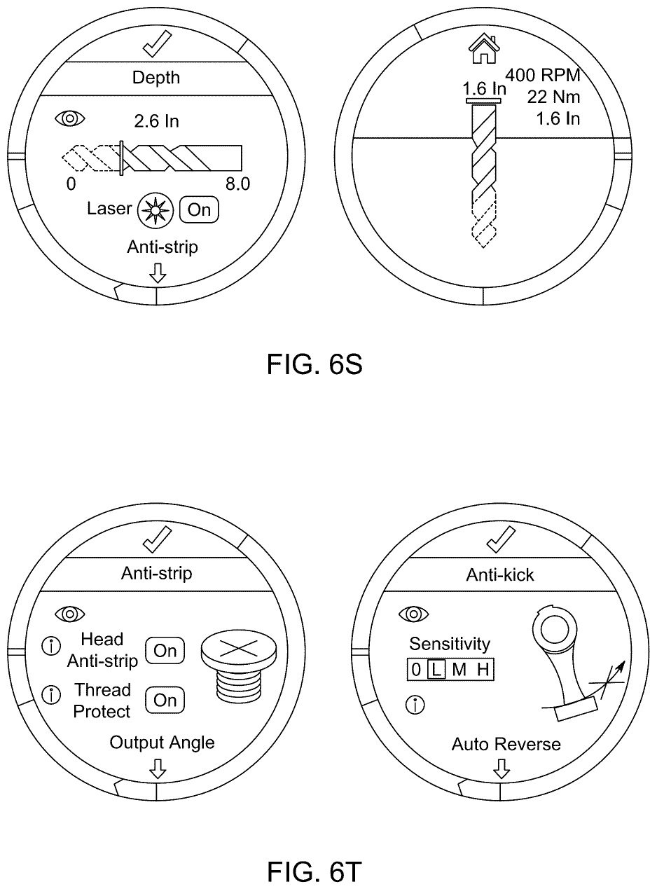

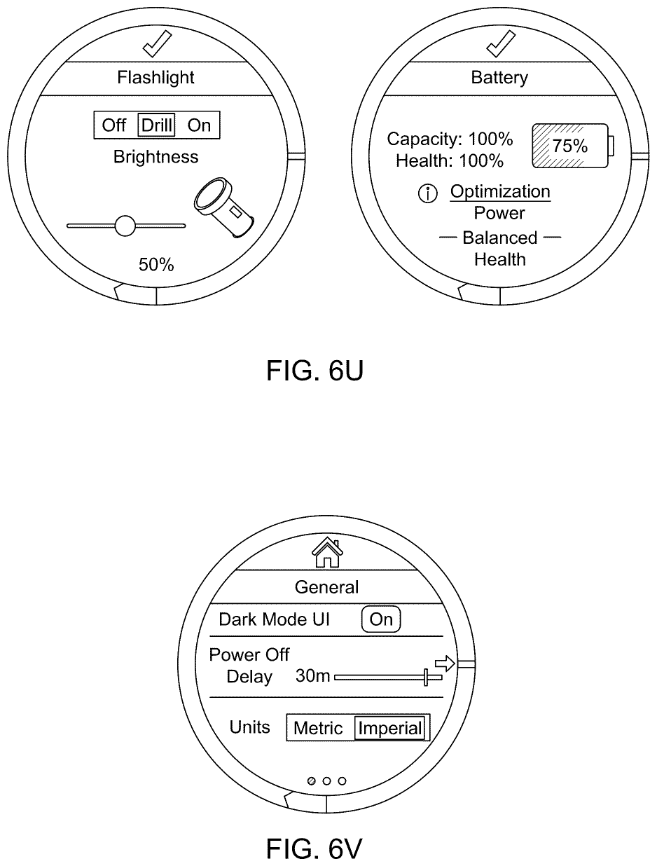

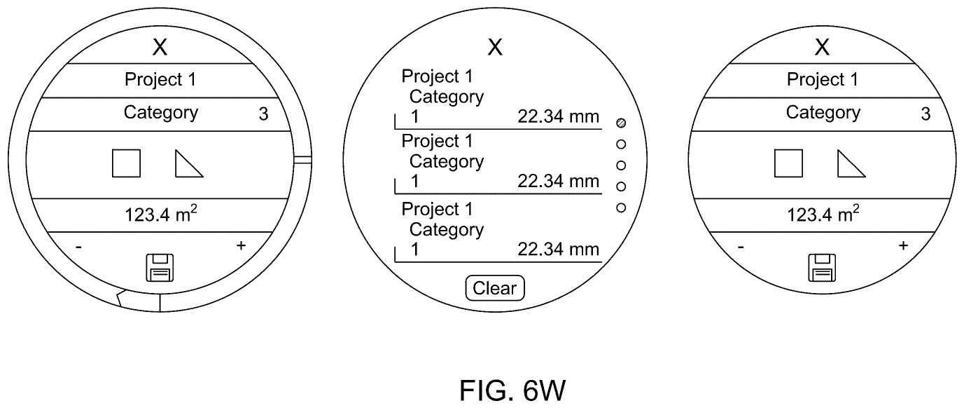

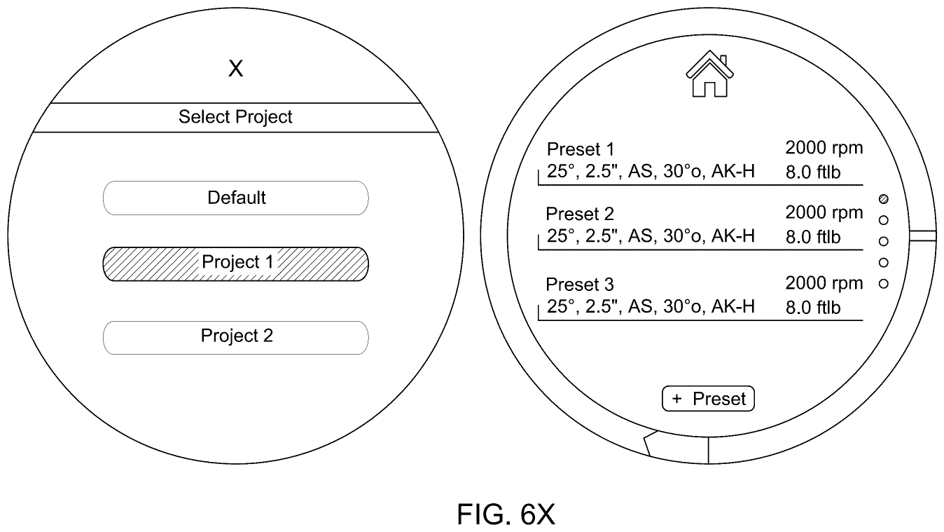

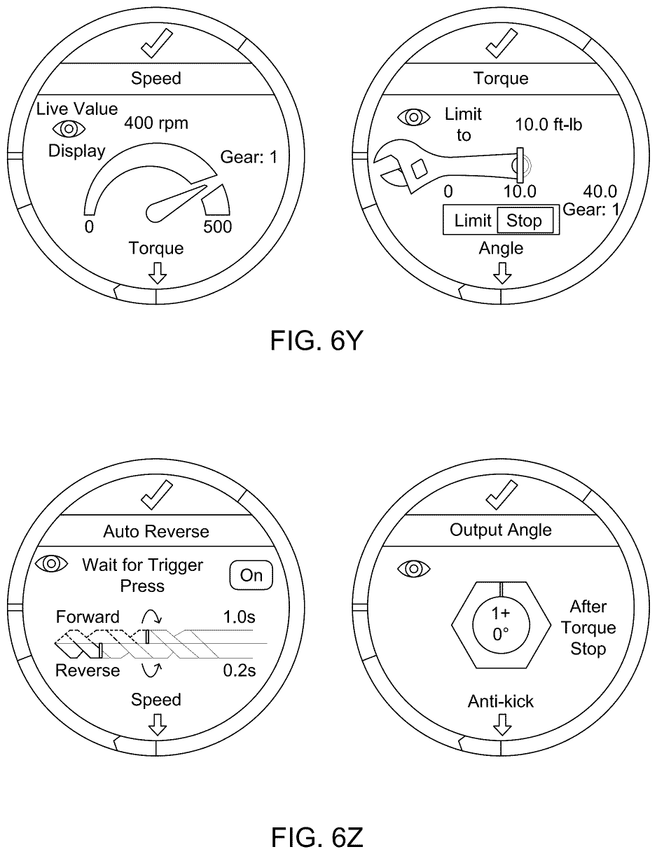

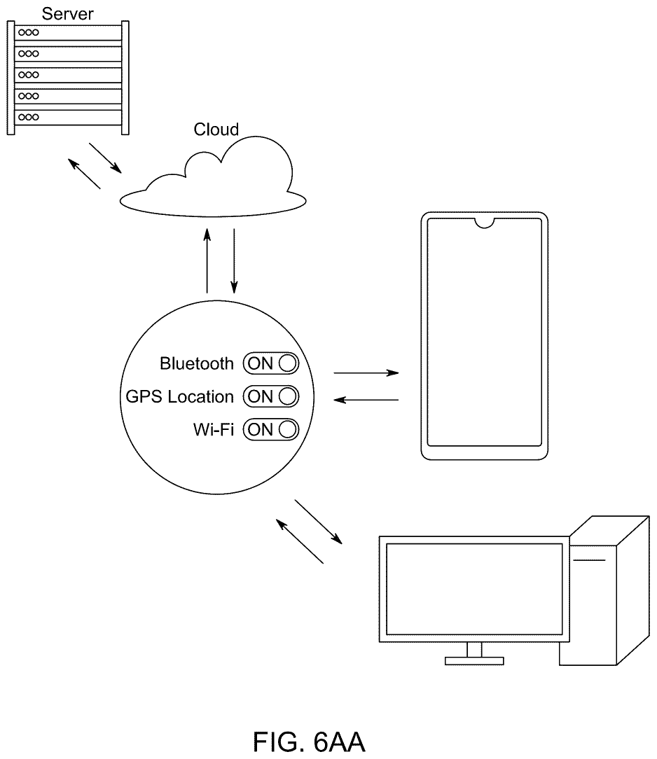

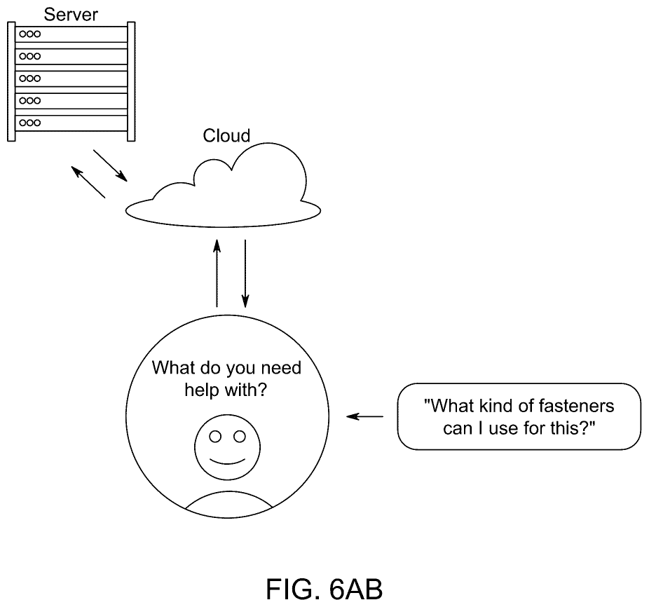

FIG. 6A to FIG. 6D provide illustrations of an interactive display of a handheld power tool assembly during a variety of operations.

According to an embodiment, the handheld power tool assembly 600 can include a display 604 comprising a graphic user interface allowing a user to have access to any settings within a microcontroller of the handheld power tool 602. In an embodiment, the handheld power tool assembly 600 includes wireless communication circuitry, such as Bluetooth circuitry, communicatively-coupled to the processing circuitry integrated into a PCB of the handheld power tool 602 allowing the user to, for example, upload graphics or settings from a cloud-based database or from a user smart device. In an embodiment, the user can choose a bit size and a material of the work piece whereby the microcontroller can access data uploaded to the memory of the microcontroller by the handheld power tool 602 manufacturer or from a cloud-based database the microcontroller can automatically determine a speed of the rotor of the motor, a torque of the motor, and a pressure most suited for the current operation.

According to an embodiment, and as shown in FIG. 6A, a display 604 can show via a touch interactive screen, a graphic providing the user with the ability to select a variety of settings of the handheld power tool 602, including a level bubble for drilling plumb, a speed measuring tool, a gear switch position setting, and a torque measuring tool. In addition, the exemplary graphic of the display 604 comprises options for the user to access other settings of the handheld power tool 602, such as a “home” screen, a screen for setting a speed of a rotor of the motor, and a screen for setting a torque of the motor. In an embodiment, the torque measuring tool detects torque of the motor in real time and the speed measuring tool detects RPM of the rotor of the motor in real time.

According to an embodiment, and as shown in FIG. 6B, a display can show via a touch interactive screen, a graphic providing the user with the ability to select a desired speed of the rotor of the motor and set a desired maximum allowable toque for a specific operation. During an operation of the handheld power tool, when the maximum allowable torque of a bit is reached, for example, a message can be generated and shown on the display that the maximum torque has been reached.

According to an embodiment, and as shown in FIG. 6C, a display can show via a touch interactive screen, a graphic providing the user with the ability to set a desired angle or rotations of the rotor of the motor. The motor will automatically stop when the user input desired angle or rotations of the rotor of the motor matches the angle or rotations of the rotor of the motor completed during operation of the handheld power tool. This exemplary feature can be performed using the motion controller or in combination with the user input torque level or user input speed of the rotor of the motor. In an embodiment, the rotor of the motor shaft movement can rotate based on the user input values and the resulting movement can be shown on the graphic shown on the display in real time.

According to an embodiment, and as shown in FIG. 6D, a display can show via a touch interactive screen, a graphic allowing the user to set a desired position of the handheld power tool via an inertial measurement unit or the user can calibrate the position of the handheld to a desired angle or surface relative to the ground. In an example, a bubble in the center of the display can reflect the orientation of the handheld power tool based on the inertial measurement unit or the user input calibration.

According to an embodiment, and as shown in FIG. 6E, a display can show timed automatic reversing features of a handheld power tool. For example, a user can set a desired time input for an automatic reverse of a rotation of the motor operation. This function can be used in the tapping or threading application, a fastening application, or in any other application where there is a need for automatic reverse of the rotation of the motor. In an embodiment, the user can set a sequence for a combination of automated forward turning and reverse turning of the rotor of the motor based on user input time settings. In an embodiment, the user can set a desired depth, via the touch interactive screen of the display, by employing a laser measuring circuit to detect a drill or tap depth of the handheld power tool in addition to the user set sequence for a combination of automated forward turning and reverse turning of the rotor of the motor based on the user input time settings.

According to an embodiment, and as shown in FIG. 6F, the display comprises a touch interactive screen allowing the user to set desired algorithms to configure various behaviors of the motor of the handheld power tool and various sensors of the handheld power tool. In an example, an algorithm allows the user to set a desired acceleration and deceleration curve of the motor depending on user input torque values and user input time values determining a user permitted time for the motor to reach the user input torque values. This exemplary function allows the user control of deceleration when higher torque levels are achieved and removes guess work from an operation, such as during surgeries or other industrial applications requiring precision.

FIGS. 6G through 6AB depict a feature set. The feature set may comprise a safety lock screen to set the motor to a non-rotate state, a power down screen, setting a forward/reverse button behavior, setting a behavior of a trigger, setting a desired depth of the drill, receiving information from a database, a screen allowing the user to select a variety of features of the handheld power tool including a flashlight, speakers, microphones, haptics, cameras, infrared cameras, thermal cameras, battery and charger information, calibration steps, data collection and transfer, and other features related to power tool applications, handling wireless transmission communications between the handheld power drill and a user device, detecting thermal readings of a drill bit (or screw or material), detecting fluid in a pump, detecting pressure, detecting anti-strip parameters, detecting parameters of a screw (or drill bit or material) based on sensors included in the handheld power tool, measuring and changing offsets, changing angle and calibration in multiple axis, automatic depth stop and dynamic movement into material, anti-stripping and anti-kick back modes, flashlight and battery information, saving data of the handheld power tool, setting speed and torque values, auto-reverse and angle motor rotation positioning, GPS circuitry functions and wireless communication circuitry functions, and AI and machine learning functions by sending data to a cloud database for processing and receiving the data processed by the cloud database from the cloud database.

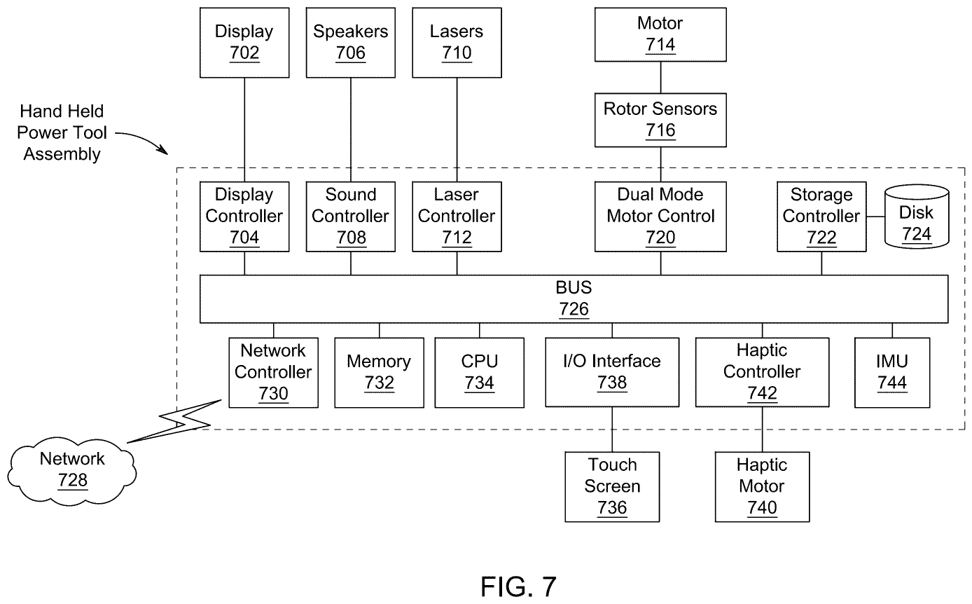

In FIG. 7, the handheld power tool assembly includes a CPU 734 which performs the processes described above/below. The process data and instructions may be stored in memory 732. These processes and instructions may also be stored on a storage medium disk 724 such as a hard drive (HDD), solid state drive (SSD), or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the handheld power tool assembly communicates, such as a server or computer.

Further, the claimed advancements may be provided as a utility application or a component of an operating system, or combination thereof, executing in conjunction with CPU 734 and an operating system such as Microsoft Windows, UNIX, LINUX, Apple MAC-OS and other systems known to those skilled in the art.

The hardware elements comprising the handheld power tool assembly may be realized by various circuitry elements, known to those skilled in the art. For example, CPU 734 may be a specially-programmed Xenon or Core processor from Intel of America or an Opteron processor from AMD of America, or may be other processor types that would be recognized by one of ordinary skill in the art. Alternatively, the CPU 734 may be implemented on an FPGA, ASIC, PLD or using discrete logic circuits, as one of ordinary skill in the art would recognize. Further, CPU 734 may be implemented as multiple processors cooperatively working in parallel to perform the instructions of the inventive processes described above.

The handheld power tool assembly in FIG. 7 also includes a network controller 730 for interfacing with network 728. As can be appreciated, the network 728 can be a public network, such as the Internet, or a private network such as an LAN or WAN network, or any combination thereof and can also include PSTN or ISDN sub-networks. The network 728 can also be wired, such as an Ethernet network, or can be wireless such as a cellular network including EDGE, 3G, 4G, and 5G wireless cellular systems. The wireless network can also be WiFi, Bluetooth, or any other wireless form of communication that is known.

The handheld power tool assembly further includes a display controller 704 for interfacing with a display 702, such as a LCD monitor. In an embodiment, the display 702 is a flexible OLED touch screen 736. A general purpose I/O interface 738 interfaces the touch screen 736 on or separate from display 702.

A sound controller 708 is also provided in the handheld power tool assembly to interface with speakers/microphone 706, thereby providing sounds and/or music. In an embodiment, the speakers/microphone 706 allow for voice control of the handheld power tool assembly and for providing notifications to the user of pertinent events.

A laser controller 712 is also provided in the handheld power tool assembly to interface with laser apertures 710 comprising laser emitting diodes and laser receivers. In an embodiment, the laser controller 712 is configured to control the operation of a laser emitting diode and laser receiver.

A haptic controller 742 is also provided in the handheld power tool assembly to interface with a haptic motor 740. The haptic motor 740 may be provided within the handle of the handheld power tool and may be configured to provide a vibratory alert to the user of the handheld power tool under specific situations. For example, if a torque value of the chuck surpasses a safe level for drilling, a vibratory alert may be provided to the user. In addition, if the user is operating the handheld power tool assembly at a height, for instance, at which the display 702 cannot be viewed, a vibratory alert can be provided when a prescribed depth of drilling has been reached. The haptic motor 740 may also be used to generate sounds, generate haptic vibrations, or in any other situation where emitting a vibration is beneficial.

The general purpose storage controller 722 connects the storage medium disk 724 with communication bus 726, which may be an ISA, EISA, VESA, PCI, or similar, for interconnecting all of the components of the handheld power tool assembly. A description of the general features and functionality of the display 702 as well as the display controller 704, storage controller 722, network controller 730, sound controller 708, laser controller 712, haptic controller 742, inertial measurement unit (IMU) 744, and general purpose I/O interface 738 is omitted herein for brevity as these features are known.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A handheld power tool, comprising:
a housing;
a motor disposed within the housing, the motor including at least one sensor;
a dual mode motor controller including a first mode and a second mode, the first mode being sensored and the second mode being sensorless;
a chuck operatively-coupled to the motor;
a display mounted on a rear surface of the housing, said display being positioned opposite the chuck; and
processing circuitry disposed within the housing, the processing circuitry being configured to control the dual mode motor controller based on a signal received from the display, wherein the processing circuitry generates a first estimation of rotor angle using the first mode, rotates a rotor of the motor based on the first estimation of the rotor angle using the first mode, determines a current torque value of the motor based on the first estimation of the rotor angle using the first mode, generates a second estimation of rotor angle using the second mode when the current torque value of the motor matches a predetermined torque value of the motor, and rotates the rotor of the motor based on the second estimation of the rotor angle using the second mode.

2. The handheld power tool according to claim 1, wherein the processing circuitry is further configured to:
receive, from a user via the display, a desired condition for controlling the dual mode motor controller using the first mode;
receive, from the user via the display, a desired condition for controlling the dual mode motor controller using the second mode;
operate the dual mode motor controller using the first mode based on the desired condition for controlling the dual mode motor controller using the first mode; and
operate the dual mode motor controller using the second mode based on the desired condition for controlling the dual mode motor controller using the second mode.

3. The handheld power tool according to claim 1, wherein the processing circuitry is further configured to:
receive, from a user via the display, a user input to switch the dual mode motor controller from the first mode to the second mode; and
rotate, via the dual mode motor controller using the second mode, the rotor of the motor.

4. The handheld power tool according to claim 1, wherein the processing circuitry is further configured to:
receive, from a user via the display, a user input to switch the dual mode motor controller from the second mode to the first mode; and
rotate, via the dual mode motor controller using the first mode, the rotor of the motor.

5. The handheld power tool according to claim 1, further comprising a first laser and a second laser, and wherein the processing circuitry is further configured to:
detect a drilling axis of the motor,
detect, via the first laser, a length of the first laser,
detect, via the second laser, a length of the second laser,
compare the drilling axis of the motor to the length of the first laser and the length of the second laser, and
generate a visual on the display, the visual being of the drilling axis of the motor compared to the length of the first laser and the length of the second laser.

6. The handheld power tool according to claim 1, further comprising a laser, and wherein the processing circuitry is further configured to:
receive, from a user via the display, a target depth of a movement of the handheld power tool,
receive, via the laser, a first length of the laser,
rotate a rotor of the motor based on the first length of the laser and the target depth of the movement of the handheld power tool,
receive, via the laser, a second length of the laser, and
end movement of the handheld power tool when the second length of the laser matches the target depth of the movement of the handheld power tool.

7. The handheld power tool according to claim 1, further comprising a laser, and wherein the processing circuitry is further configured to:
receive, from a user via the display, a target depth of a movement of the handheld power tool,
receive, via the laser, a first length of the laser,
rotate a rotor of the motor in a first direction based on the first length of the laser and the target depth of the movement of the handheld power tool,
receive, via the laser, a second length of the laser,
rotate a rotor of the motor in a second direction when the second length of the laser matches the target depth of the movement of the handheld power tool, and
end movement of the handheld power tool when a current depth of the movement of the handheld power tool matches the first length of the laser.

8. The handheld power tool according to claim 1, wherein the processing circuitry is further configured to:
stop a rotation of a rotor of the motor when a predetermined torque level is detected, and
generate a visual of the rotation of the rotor of the motor on the display.

9. The handheld power tool according to claim 1, wherein the processing circuitry is further configured to:
reverse a direction of a rotation of a rotor of the motor when a predetermined torque level is detected, and
generate a visual of the rotation of the rotor of the motor on the display.

10. The handheld power tool according to claim 1, further comprising inertial measurement circuitry, the inertial measurement circuitry configured to:
receive, via the display, a target value of an angle relative to a predetermined position, and
generate, via the processing circuitry, a visual when the target value of an angle relative to the predetermined position matches a current value of an angle of the handheld power tool.

11. The handheld power tool according to claim 1, further configured to:
receive, via the display, a first value for timing a cycle of a rotation of the motor in a first direction,
receive, via the display, a second value for timing a cycle of a rotation of the motor in a second direction, and
rotate a rotor of the motor in a sequence based on the first value for timing the cycle of the rotation of the motor in the first direction and the second value for timing the cycle of the rotation of the motor in the second direction.

12. The handheld power tool according to claim 1, further comprising a sensor, the sensor being configured to:
detect a current value of a drill bit of the handheld power tool;
transmit the current value of the drill bit of the handheld power tool to the processing circuitry; and
end an operation of the handheld power tool when the current value of the drill bit of the handheld power tool matches a predetermined value of the drill bit of the handheld power tool.

13. A method for controlling a handheld power tool, the handheld power tool comprising a housing, a motor disposed within the housing, the motor including at least one sensor, a dual mode motor controller including a first mode and a second mode, the first mode being sensored and the second mode being sensorless, a chuck operatively-coupled to the motor, a display mounted on a rear surface of the handheld power tool, said display being positioned opposite the chuck, and processing circuitry disposed within the housing, the processing circuitry being configured to control the dual mode motor controller based on a signal received from the display, the method comprising:
generating, via the processing circuitry, a first estimation of rotor angle using the first mode;
rotating a rotor of the motor based on the first estimation of the rotor angle using the first mode;
determining, via the processing circuitry, a current torque value of the motor based on the first estimation of the rotor angle using the first mode;
generating, via the processing circuitry, a second estimation of rotor angle using the second mode when the current torque value of the motor matches a predetermined torque value of the motor; and
rotating the rotor of the motor based on the second estimation of the rotor angle using the second mode.

14. The method according to claim 13, further comprising:
receiving, via the display, a target torque value; and
generating, via the processing circuitry, a signal to rotate the rotor of the motor at a torque value that matches the target torque value.

15. The method according to claim 13, further comprising:
receiving, via the display, a target speed of a rotor value; and
generating, via the processing circuitry, a signal to rotate the rotor of the motor at a speed of the rotor that matches the target speed of the rotor value.

16. The method according to claim 13, further comprising:
receiving, from a user, a target angle value of a position of a rotor of the motor,
detecting an angle value of the position of the rotor of the motor,
comparing the target angle value of the position of the rotor of the motor to the angle value of the position of the rotor of the motor, and
rotating the rotor of the motor until the angle value of the position of the rotor of the motor matches the target angle value of the position of the rotor of the motor.

17. The method according to claim 13, further comprising:
detecting a drilling axis of the motor,
detecting, via a laser, a length of the laser,
detecting, via a second laser, a length of the second laser,
comparing the drilling axis of the motor to the length of the laser and the length of the second laser, and
generating a visual on the display, the visual being of the drilling axis of the motor compared to the length of the laser and the length of the second laser.

18. A handheld power tool, comprising:
a housing, a motor disposed within the housing, the motor including at least one sensor, a dual mode motor controller including a first mode and a second mode, the first mode being sensored and the second mode being sensorless, a chuck operatively-coupled to the motor, a display mounted on a rear surface of the housing, said display being positioned opposite the chuck, and processing circuitry disposed within the housing, the processing circuitry being configured to control the dual mode motor controller based on a signal received from the display, wherein the processing circuitry generates a first estimation of rotor angle using the first mode, rotates a rotor of the motor based on the first estimation of the rotor angle using the first mode, determines a current torque value of the motor based on the first estimation of the rotor angle using the first mode, generates a second estimation of rotor angle using the second mode when the current torque value of the motor matches a predetermined torque value of the motor, and rotates the rotor of the motor based on the second estimation of the rotor angle using the second mode.

19. The handheld power tool according to claim 18, further comprising inertial measurement circuitry configured to detect a position and movement of the handheld power tool.

20. The handheld power tool according to claim 18, further comprising a storage configured to receive, via wireless communication, data from a remote database.
